(19) United States
(12) Patent Application Publication
(10) Pub. No.: US 2011/0268403 A1
(43) Pub. Date: Nov. 3, 2011

(54) MOUNTING AND STRAIN RELIEF DEVICE

(76) Inventors: Tomasz A. Ciechomski, Lowicz (PL); Bryan R. Roark, Hickory, NC (US); Tadeusz M. Tenderenda, Warszawa (PL)

(21) Appl. No.: 12/771,513

(22) Filed: Apr. 30, 2010

(51) Int. Cl. G02B 6/00

(52) U.S. Cl. 385/134

(57) ABSTRACT

Mounting and strain relief device for mounting a subassembly such as a plug or a socket or a furcation adapter being part of to a first fiber optic cable, and being received in a fastening device to a second fiber optic cable such as a distribution cable. The mounting and strain relief device has a plate like basic body having a mounting portion and two opposite end sections. The basic body of the device is mountable to the second fiber optic cable via the mounting section and both end sections are designed for receiving the fastening device for receiving and securing the subassembly being part of the first fiber optic cable.

### BACKGROUND

The present application relates to a mounting and strain relief device, for mounting a subassembly such as a connector adapter or a furcation adapter that is part of a first fiber optic or hybrid cable such as a tether cable. In use, the device is mounted to a second fiber optic or hybrid cable such as a distribution cable or other suitable structure, and secures the subassembly of the first fiber optic cable or hybrid cable. Furthermore, the present application relates to a cabling system making use of such a mounting and strain relief device.

In the world with an ever-increasing appetite for broadband bandwidth, fiber optic cables have become an important part of communication networks due to there large bandwidth capacity. Additionally, fiber optic cables can transmit voice signals, data signals and video signals for very long distances with very high speed. Developments of fiber optic communication networks have been driving optical fiber closer to the user and may even provide the end user with optical fiber connectivity. For instance, one kind of network technology known as FTTH technology (fiber to the home) requires extending a fiber optic communication network closer to the subscribers. Additionally, such communication networks include large number of distribution points for routing fiber toward the user or subscriber.

The distribution points are key parts of the communication network and may be indoor or outdoor depending on the communication network. By way of example, different kind of buildings like multi dwelling units (MDU) and block of flats require complicated cabling systems which might mean that there are many separated cables, each one to connect one subscriber to an optical fiber. Installation of many cables which provide the connection between a main distribution point (which usually is located in the basement or in another place of the building) and the end user may cause many problems with routing through the wall or levels of the building. As a result, such installations consume a lot of time and costs.

Another way to provide the connection between the main distribution point and the end user or subscriber is using a cabling system comprising a distribution cable with branched off tether cables, whereby the distribution cable can be connected to a distribution point, and whereby the tether cables (also known as drop cables) are routed toward the desired locations and/or devices from the distribution cable.

In order to branch off a tether cable from a distribution cable it is necessary to branch off at least one optical fiber from the fiber optic distribution cable at a so-called mid-span access location of the distribution cable and to connect the branched off optical fiber to an optical fiber of the tether cables. This may be done by using e.g. a furcation adapter or connector adapter.

There are also applications in which not only optical fibers but also copper conductors have to be run in the cables (i.e., hybrid cables), both the optical fibers and the copper conductors then having to be connected to one another near distribution points. An application in which both optical fibers and copper conductors have to be run in the cables is, for example, known as “radio over fiber” with distributed antenna systems. In the case of so-called “radio over fiber”, a broadband radio signal is transmitted over the optical fibers to antenna units, which convert the optical signal into an RF signal, it being necessary for the purpose of supplying power to the antenna units for the above cables not only to be used for running the optical fibers, which serve for the transmission of the optical broadband radio signal, but also to be used for running copper conductors, which ultimately serve for supplying power to the antenna units.

In case of so-called “radio over fiber” or other similar networks, optical fibers and copper conductors have to be branched off at mid-span access locations of a hybrid distribution cable, whereby the branched off optical fibers and copper conductors have to be connected to optical fibers and copper conductors of hybrid tether cables. Again, this can be done by using furcation adapters or connector adapters.

The prior art document EP 2 154 556 A1 discloses a fastening device for receiving a furcation adapter or connector adapter and for mounting the same to wall of distribution panel or distribution cabinet.

However, no solutions are known for mounting a furcation adapter or connector adapter to a cable such as a distribution cable or the like, and to provide sufficient strain relief to branched off cables, e.g. to branched off tether cables, and to furcation adapters or connector adapters.

### SUMMARY

Against this background, a novel mounting and strain relief device is disclosed that provides sufficient strain relief to the tether cables and furcation adapters or connector adapters. Furthermore, a novel cabling system making use of such a mounting and strain relief device is disclosed.

The novel mounting and strain relief device comprises a plate like basic body, the plate like basic body having a middle section and two opposite end sections, wherein a mounting portion of the basic body is secured to a distribution cable (i.e., a second cable), and wherein the mounting and strain relief device is designed to receive and secure a fastening device which receives a furcation adapter or a connector adapter being assigned to a first cable such as a tether cable.

Consequently, the novel mounting and strain relief device allows an easy connection of optical fibers of a tether cable to optical fibers of a distribution cable and provides sufficient strain relief to the tether cable and to the furcation adapter or connector adapter.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 shows a first embodiment of a mounting and strain relief device;

FIG. 2 shows the mounting and strain relief device of FIG. 1 together with a distribution cable and a fastening device receiving a furcation adapter; and

FIG. 3 shows a second embodiment of a mounting and strain relief device.

### DETAILED DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

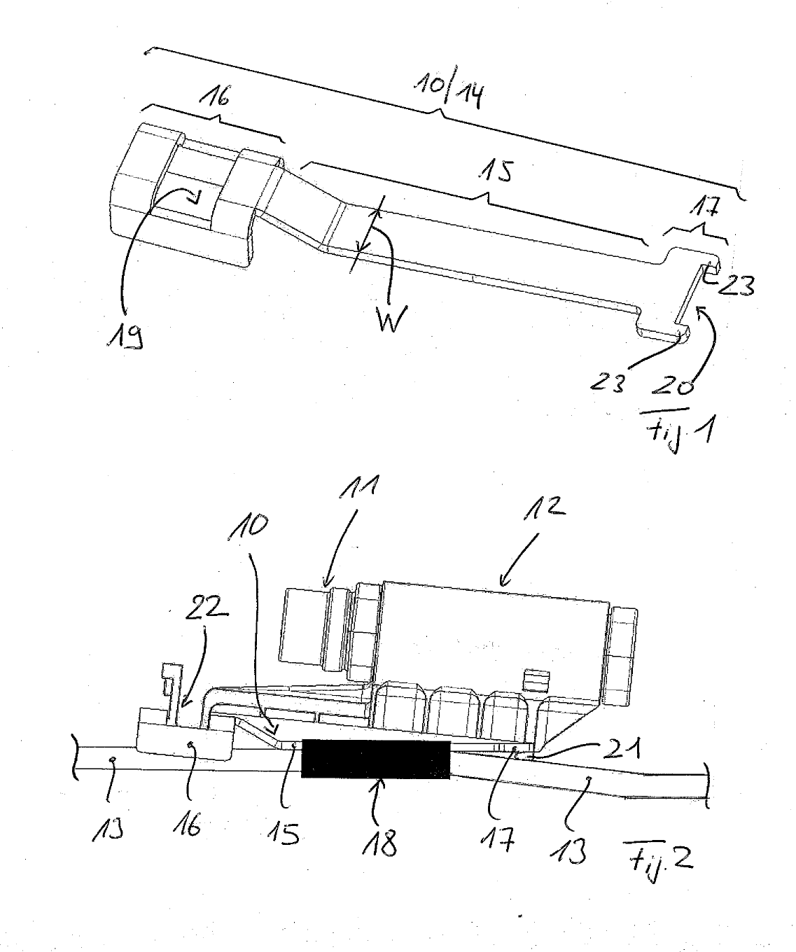

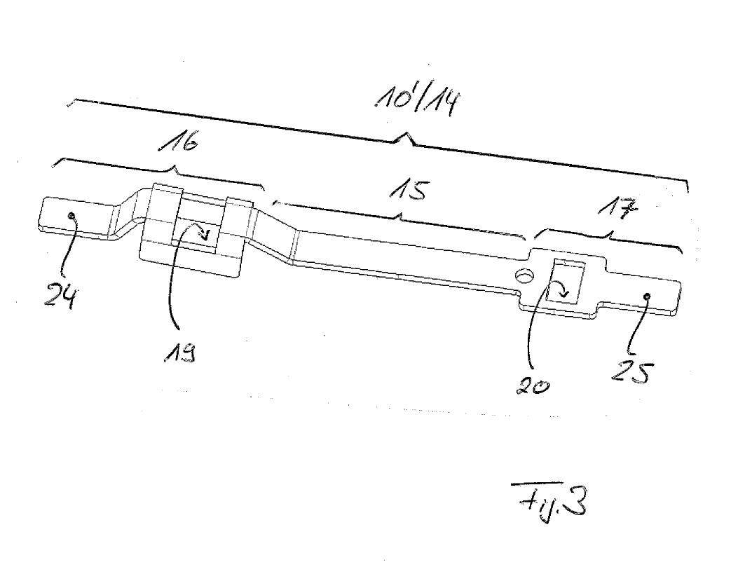

FIG. 1 shows a perspective view of a first embodiment of a mounting and strain relief device 10. The mounting and strain relief device 10 is preferably used to mount a subassembly such as furcation adapter 11 or a connector adapter (see FIG. 2) being assigned to a tether cable (not shown for clarity) and being received in a fastening device 12 to a distribution cable 13 (i.e., second cable). In other words, the tether cable is attached to the a portion of the furcation adapter 11 or connector adapter and the furcation adapter 11 or connector adapter is secured to fastening device 12.

It should be understood that the mounting and strain relief device 10 can also be used in connection with other fiber optic cables or hybrid cables like indoor cables or drop cables or access cables. Furthermore, it should be understood that the mounting and strain relief device 10 can be used to mount other subassemblies like a plug or a socket being received in a fastening device 12 to a fiber optic cable or hybrid cable. Thus, fiber optic cable(s) includes hybrid cables having one or more optical fibers.

The mounting and strain relief device 10 comprises a plate like basic body 14, the plate like basic body 14 has a middle section (not numbered) and two opposite end sections 16, 17. As used herein, opposite end sections means spaced apart sections for receiving and securing fastening device 12 and not that the sections are literally located on the end of the basic body 14, but which is possible. The basic body 14 and thereby the mounting and strain relief device 10 is mountable to the distribution cable 13 through a mounting portion 15. In this embodiment, the mounting portion 15 is the middle section of mounting and strain relief device 10. According to FIG. 1, the middle section is mounted to the distribution cable 13 using a fastening element 18 such as a heat shrink element.

It should be understood that other fastening elements 18 may be used. By way of example, fastening elements 18 may be tapes, tie wraps or cable binders for mounting (i.e. securing) the middle section 15 of the plate like basic body 14 to the distribution cable 13 (e.g., second cable).

The mounting portion 15 of the plate like basic body 14 preferably has a suitable width W for securing to the outer diameter or profile of the distribution cable 13 (e.g., second cable) to which the mounting and strain relief device 10 is mountable.

Both end sections 16, 17 are designed to receive the fastening device 12 which receives the furcation adapter 11 being assigned to a tether cable. By way of example, the fastening device 12 may “snap-fit” to the mounting and strain relief device 10 without the use of tools, but other embodiments may use a fastener for attaching the fastening device 12.

In the embodiment shown one of the end sections 16 of the plate like basic body 14 is angled with respect to the middle section. This end section 16 is angled in such a way with respect to the middle section that the distance or gap between the angled end section 16 and the distribution cable 13 is larger than the distance or gap between the middle section and the distribution cable 13. It should be understood that both end sections can be angled in such a way with respect to the middle section. Moreover, each of the end sections 16, 17 of the plate like basic body 14 comprises a recess 19, 20 to receive anchoring elements of the fastening device 12; however, other variations of the device are possible.

The first end section 16 of the two opposite end sections 16, 17 of the plate like basic body 14 is designed to receive a first anchoring element (not shown) which is assigned to a first end of the fastening device 12. A second end section 17 of the two opposite end sections 16, 17 of the plate like basic body 14 is designed to receive a second anchoring element 21 which is assigned to a second end of the fastening device 12. Of course, the mounting and strain relief device may be configured for mounting fastening devices having other types of mounting structures as the anchoring elements. For instance, the anchoring elements may fit into respective apertures on the mounting and strain relief device and secure the device by sliding the fastening device with respect to the mounting and strain relief device.

Returning to FIGS. 1 and 2, the first end section 16 of the plate like basic body 14 is designed to receive a first anchoring element (not shown) of the fastening device 12 being an integral part of an U-shaped element 22 of the fastening device 12. A closed portion of the U-shaped element 22 and thereby the first anchoring element projects in such a way with respect to an underside of the fastening device 12 that the closed portion of the U-shaped element 22 and thereby the first anchoring can be inserted into the recess 19 of the first end section 16 of the plate like basic body 14.

Additionally, recess 19 is provided at the first, angled end section 16 of the mounting and strain relief device 10 is designed as an orifice. The angled end section 16 of the mounting and strain relief device 10, 10′ reduces the tension between the U-shaped element 22 of the fastening device 12 and the distribution cable 13. In other words, the angle end section keeps the U-shaped element from contacting the distribution cable 13.

The second end section 17 of the plate like basic body 14 is designed to receive the second anchoring element 21 of the fastening device 12, whereby the second anchoring element 21 projects in such a way with respect to the underside of the fastening device 12 that the second anchoring element 12 can be inserted into the recess 20 of the second end section 17 of the plate like basic body 14.

The recess 20 provided at the second end section 17 of the mounting and strain relief device 10 is designed as a cut out having two opposite protrusions 23. Opposite protrusions 23 allow secure attachment of the second anchoring element 21 of fastening device 12 thereto. In other words, the protrusions 23 provide side pull relief, thereby inhibiting unintended release.

Other embodiments using the concepts disclosed are possible for securing and/or strain relieving a fastening device secured to a first cable. Illustratively, FIG. 3 shows a perspective view of a second embodiment of a mounting and strain relief device 10′. The mounting and strain relief device 10′ of FIG. 3 is different from the mounting and strain relief device 10 of FIG. 1 since both end sections 16 and 17 comprise mounting portions 24, 25 which can be used like the middle section discussed above for mounting and strain relieving device 10′ to the distribution cable 13 or other structure using fastening elements 18. The recess 20 provided at the second end section 17 of the mounting and strain relief device 10′ is designed as an orifice.

The mounting portion 24 of the end section 16 is angled with respect to the end section 16. Both mounting portions 24,25 run preferably in the same plane like the middle section of FIG. 1 so that it may be mounted to a second cable. However, other embodiments can have the mounting portions of the mounting and strain relief device in other planes as desired. Other variations include having only one of the end sections 16 or 17 including the mounting portion 24 or 25.

The mounting and strain relief devices 10, 10′ are preferably made from metal. However, the mounting and strain relief device 10, 10′ can be also made from different materials like plastic or other suitable materials. The mounting and strain relief devices 10, 10′ can be fixed to the distribution cable 13 or other suitable structure for providing strain relief for the tether cable and/or the furcation adapter 11.

Advantageously, the mounting and strain relief device 10, 10′ has a compact design. In one embodiment, the mounting and strain relief device 10, 10′ can be factory premounted on the distribution cable 13 and easily pulled with the distribution cable 13 through narrow spaces and ducts. No additional hardware or protection is needed to strain relief the tether cable and the furcation adapter 11, which speeds installation.

One or more mounting and strain relief devices 10, 10′ can be mounted on a distribution cable 13. After the or each mounting and strain relief device 10, 10′ has been mounted on the distribution cable 13, a tether cable can be secured to it through a furcation adapter 11. The furcation adapter 11 is mounted in the fastening device 12 and then the whole assembly can be mounted to the mounting and strain relief device 10, 10′.

The disclosure is also directed to methods of securing a subassembly of a first fiber optic cable to a second fiber optic cable. The method comprises the steps of providing a mounting and strain relief device, securing the subassembly of the first fiber optic cable to a fastening device, securing the fastening device to the mounting and strain relief device, and attaching the mounting and strain relief device to the second fiber optic cable. In preferred methods, the step of securing the fastening device to the mounting and strain relief device does not require tools.

The mounting and strain relief device 10, 10′ may be used in any suitable network cable system. For instance, suitable cabling systems are “fiber to the home” (FTTH) applications or in a “radio over fiber” (ROF) applications. In both applications the respective cabling system comprises a distribution cable 13 (i.e., second cable) having at least one mid-span access location, whereby at the or each mid-span access location at least one optical fiber of the distribution cable 13 is branched off from the distribution cable 13 and is connected to at least one optical fiber of a tether cable (first cable) using a furcation adapter 11 or connector adapter, and whereby at the or each mid-span access location the respective furcation adapter 11 or connector adapter is received in a fastening device 12 which is mounted to the distribution cable 13 using a mounting and strain relief device 10 or 10′. Moreover, the concepts disclosed may be used with other cables having optical fibers and/or copper conductors that are branched off and connected to other devices.

Therefore, it is to be understood that the embodiments are not to be limited to the specific embodiments disclosed and that modifications and other embodiments are intended to be included within the scope of the appended claims. It is intended that the embodiments cover the modifications and variations of this invention provided they come within the scope of the appended claims and their equivalents. Although specific terms are employed herein, they are used in a generic and descriptive sense only and not for purposes of limitation.

1. A mounting and strain relief device for mounting a subassembly of a first fiber optic cable and being received in a fastening device to a second fiber optic cable comprising:
a plate like basic body, the plate like basic body having a mounting portion and two opposite end sections, wherein the basic body is mountable to the second fiber optic cable through the mounting portion, and wherein both end sections are designed to receive the fastening device which receives the subassembly being assigned to the first fiber optic cable.

2. The device of claim 1, wherein at least one of the end sections of the plate like basic body is angled with respect to the middle section.

3. The device of claim 1, wherein at least one of the end sections or the middle section comprises a mounting portion.

4. The device of claim 1, wherein each of the end sections of the plate like basic body comprises a recess for receiving anchoring elements of the fastening device.

5. The device of claim 4, wherein a first end section of the two opposite end sections of the plate like basic body is designed to receive a first anchoring element which is assigned to a first end of the fastening device, and that a second end section of the two opposite end sections of the plate like basic body is designed to receive a second anchoring element which is assigned to a second end of the fastening device.

6. The device of claim 5, wherein the first end section of the plate like basic body is designed to receive the first anchoring element of the fastening device being an integral part of an U-shaped element of the fastening device, whereby a closed portion of the U-shaped element and thereby the first anchoring element projects in such a way with respect to an underside of the fastening device that the closed portion and thereby the first anchoring can be inserted into the recess at the first end section of the plate like basic body.

7. The device of claim 5, wherein the recess at the first end section of the plate like basic body is an orifice.

8. The device of claim 6, wherein the second end section of the plate like basic body is designed to receive a second anchoring element of the fastening device, whereby the second anchoring element projects in such a way with respect to the underside of the fastening device that the second anchoring element can be inserted into the recess at the second end section of the plate like basic body.

9. The device of claim 5, wherein the recess at the second end of the plate like basic body is designed as a cut out having two opposite protrusions.

10. A cabling system comprising a distribution cable having at least one mid-span access location, whereby at the or each mid-span access location at least one optical fiber of the distribution cable is branched off from the distribution cable and is connected to at least one optical fiber of a tether cable using a furcation adapter, and whereby at the or each mid-span access location the respective furcation adapter is received in a fastening device which is mounted to the distribution cable using a mounting and strain relief device as defined in claim 1.

11. A method of securing a subassembly of a first fiber optic cable to a second fiber optic cable, comprising the steps of:
providing a mounting and strain relief device;
securing the subassembly of the first fiber optic cable to a fastening device;
securing the fastening device to the mounting and strain relief device; and
attaching the mounting and strain relief device to the second fiber optic cable.

12. The method of claim 11, wherein the step of securing the fastening device to the mounting and strain relief device does not require tools.
